(19) United States
(12) Patent Application Publication
(10) Pub. No.: US 2019/0346373 A1
(43) Pub. Date: Nov. 14, 2019

(54) INFORMATION RECORDING SYSTEM, INFORMATION RECORDING DEVICE, AND INFORMATION RECORDING METHOD

(71) Applicant: OLYMPUS CORPORATION, Tokyo (JP)

(72) Inventor: Seiji TATSUTA, Tokyo (JP)

(73) Assignee: OLYMPUS CORPORATION, Tokyo (JP)

(21) Appl. No.: 16/521,058

(22) Filed: Jul. 24, 2019

Related U.S. Application Data
(63) Continuation of application No. PCT/JP2017/002741, filed on Jan. 26, 2017.

(51) Int. Cl. G01N 21/88; G06T 7/00; G10L 15/26; G06K 9/00

(52) U.S. Cl. CPC G01N 21/8851; G01N 21/8803; G06K 9/00671; G10L 15/265; G06T 7/0004

(57) ABSTRACT

An information recording system includes an object information acquisition unit, an image acquisition unit, a recording unit, a reading unit, and a display unit. The object information acquisition unit acquires object information about an object. The image acquisition unit acquires image information indicating a situation in which the object information was acquired. The recording unit records the object information and the image information on a recording medium such that the object information and the image information are associated with each other. The reading unit reads the object information and the image information from the recording medium. The display unit displays the object information and the image information read by the reading unit such that the object information and the image information are associated with each other.

The present application is a continuation application based on International Patent Application No. PCT/JP2017/002741, filed on Jan. 26, 2017, the content of which is incorporated herein by reference.

### BACKGROUND OF THE INVENTION

### Field of the Invention

The present invention relates to an information recording system, an information recording device, and an information recording method.

### Description of Related Art

The record of a situation at an observation site as well as the record of information obtained by observation is regarded to be important to promote the use of data and prevent fraud. For example, there are examples of a laboratory notebook of a researcher, findings of a doctor, a construction site deployment report, and the like as examples of the record of the situation at the observation site. Also, the declining birthrate, aging population, and the shortage of skilled workers have become a problem in every field. For the skill succession and education, the importance of recording of an on-site situation is increasing more and more.

Conventional observation devices record only information of an object obtained by observing the object. At present, a user records a situation of an observation site by writing by hand. On the other hand, because users are working in various environments and situations at a site, there is a case in which it is difficult to record at a site. There are cases in which the users may not use their hands for reasons of safety or hygiene. In these cases, there is a possibility that a user will cause omissions in recording or erroneous recording due to recording of an on-site situation on the basis of ambiguous memories after observation.

On the other hand, technology for recording information of an object and other information in association has been disclosed. For example, in the technology disclosed in Japanese Unexamined Patent Application, First Publication No. 2008-199079, the appearance of an object is imaged and a sound uttered by an operator during imaging is acquired. The acquired image of the object and the acquired sound of the operator are recorded in association. In the technology disclosed in Japanese Unexamined Patent Application, First Publication No. 2008-085582, an image and a sound associated therewith are transmitted from a camera to a server. The server converts the received sound into text and generates information to be added to the image on the basis of a conversion result. The server stores the received image in association with the information generated on the basis of the sound.

### SUMMARY OF THE INVENTION

According to a first aspect of the present invention, an information recording system includes an object information acquisition unit, an image acquisition unit, a recording unit, a reading unit, and a display unit. The object information acquisition unit acquires object information about an object. The image acquisition unit acquires image information indicating a situation in which the object information was acquired by the object information acquisition unit. The recording unit records the object information and the image information on a recording medium such that the object information and the image information are associated with each other. The reading unit reads the object information and the image information from the recording medium. The display unit displays the object information and the image information read by the reading unit such that the object information and the image information are associated with each other.

According to a second aspect of the present invention, in the first aspect, the image acquisition unit may acquire the image information including an image of surroundings of the object.

According to a third aspect of the present invention, in the second aspect, the surroundings of the object may include a device equipped with the object information acquisition unit.

According to a fourth aspect of the present invention, in the second aspect, the surroundings of the object may include an observer who observes the object.

According to a fifth aspect of the present invention, in the first aspect, the image acquisition unit may be disposed at a position of a viewpoint of an observer who observes the object or a position near the viewpoint.

According to a sixth aspect of the present invention, in the first aspect, the information recording system may further include a situation information acquisition unit configured to acquire situation information that indicates a type of situation in which the object information was acquired and is information other than the image information of the object.

According to a seventh aspect of the present invention, in the sixth aspect, the situation information may be information about at least one of a time point, a place, and a surrounding environment of the object.

According to an eighth aspect of the present invention, in the sixth aspect, the situation information may be device information about a device including the object information acquisition unit.

According to a ninth aspect of the present invention, in the eighth aspect, the device information may be a setting value of the device.

According to a tenth aspect of the present invention, in the first aspect, the recording unit may record the object information, the image information, and time point information on the recording medium such that the object information, the image information, and the time point information are associated with each other. The reading unit may read the object information and the image information associated with each other from the recording medium on the basis of the time point information.

According to an eleventh aspect of the present invention, in the first aspect, the information recording system may further include a sound acquisition unit and a sound processing unit. The sound acquisition unit acquires sound information based on a sound uttered by an observer who observes the object. The sound processing unit converts the sound information acquired by the sound acquisition unit into text information The recording unit may record the object information, the image information, and the text information on the recording medium such that the object information, the image information, and the text information are associated with each other. The reading unit may read the object information, the image information, and the text information from the recording medium. The display unit may display the object information, the image information, and the text information read by the reading unit such that the object information, the image information, and the text information are associated with each other.

According to a twelfth aspect of the present invention, in the first aspect, the information recording system may further include a sound acquisition unit and a sound output unit. The sound acquisition unit acquires sound information based on a sound uttered by an observer who observes the object. The recording unit may record the object information, the image information, and the sound information on the recording medium such that the object information, the image information, and the sound information are associated with each other. The reading unit may read the object information, the image information, and the sound information from the recording medium. The display unit may display the object information and the image information read by the reading unit such that the object information and the image information are associated with each other. The sound output unit may output a sound based on the sound information read by the reading unit.

According to a thirteenth aspect of the present invention, in the first aspect, the information recording system may further include a sound acquisition unit and a sound processing unit. The sound acquisition unit acquires sound information based on a sound uttered by an observer who observes the object. The recording unit may record the object information, the image information, and the sound information on the recording medium such that the object information, the image information, and the sound information are associated with each other. The reading unit may read the sound information from the recording medium. The sound processing unit may convert the sound information read by the reading unit into text information. The recording unit may associate the text information with the object information and the image information recorded on the recording medium and record the text information on the recording medium. The reading unit may read the object information, the image information, and the text information from the recording medium. The display unit may display the object information, the image information, and the text information read by the reading unit such that the object information, the image information, and the text information are associated with each other.

According to a fourteenth aspect of the present invention, in the first aspect, the object information acquisition unit may acquire the object information by imaging the object. The image acquisition unit may acquire the image information by imaging the surroundings of the object with a visual field wider than that of the object information acquisition unit.

According to a fifteenth aspect of the present invention, an information recording device includes an input unit and a recording unit. Object information acquired by an object information acquisition unit and image information indicating a situation in which the object information was acquired by the object information acquisition unit are input to the input unit. The object information is information about an object. The recording unit records the object information and the image information on a recording medium such that the object information and the image information are associated with each other.

According to a sixteenth aspect of the present invention, an information recording method includes an object information acquisition step, an image acquisition step, a recording step, a reading step, and a display step. In the object information acquisition step, an object information acquisition unit acquires object information about an object. In the image acquisition step, an image acquisition unit acquires image information indicating a situation in which the object information was acquired by the object information acquisition unit. In the recording step, a recording unit records the object information and the image information on a recording medium such that the object information and the image information are associated with each other. In the reading step, a reading unit reads the object information and the image information from the recording medium. In the display step, a display unit displays the object information and the image information read by the reading unit such that the object information and the image information are associated with each other.

### BRIEF DESCRIPTION OF THE DRAWINGS

FIG. 1 is a block diagram showing a configuration of an information recording system according to a first embodiment of the present invention.

FIG. 2 is a flowchart showing a procedure of processing of the information recording system according to the first embodiment of the present invention.

FIG. 3 is a diagram showing a schematic configuration of a microscope system according to the first embodiment of the present invention.

FIG. 4 is a diagram showing a schematic configuration of an endoscope system according to the first embodiment of the present invention.

FIG. 5 is a diagram showing a schematic configuration of an examination system according to the first embodiment of the present invention.

FIG. 6 is a diagram showing a schematic configuration of an inspection system according to the first embodiment of the present invention.

FIG. 7 is a diagram showing a schematic configuration of a work recording system according to the first embodiment of the present invention.

FIG. 8 is a reference diagram showing a screen of a display unit in the information recording system according to the first embodiment of the present invention.

FIG. 9 is a reference diagram showing a screen of the display unit in the information recording system according to the first embodiment of the present invention.

FIG. 10 is a block diagram showing a configuration of an information recording system according to a first modified example of the first embodiment of the present invention.

FIG. 11 is a block diagram showing a configuration of an information recording system according to a second modified example of the first embodiment of the present invention.

FIG. 12 is a reference diagram showing a flow of processing and inspection in a third modified example of the first embodiment of the present invention.

FIG. 13 is a timing chart showing timings at which object information and image information are acquired in the third modified example of the first embodiment of the present invention.

FIG. 14 is a reference diagram showing object information and image information recorded on a recording medium in the third modified example of the first embodiment of the present invention.

FIG. 15 is a reference diagram showing a screen of a display unit in the third modified example of the first embodiment of the present invention.

FIG. 16 is a block diagram showing a configuration of an information recording system according to a second embodiment of the present invention.

FIG. 17 is a block diagram showing a configuration of an information recording device according to the second embodiment of the present invention.

FIG. 18 is a flowchart showing a procedure of processing of the information recording device according to the second embodiment of the present invention.

### DETAILED DESCRIPTION OF THE INVENTION

Embodiments of the present invention will be described with reference to the drawings.

### First Embodiment

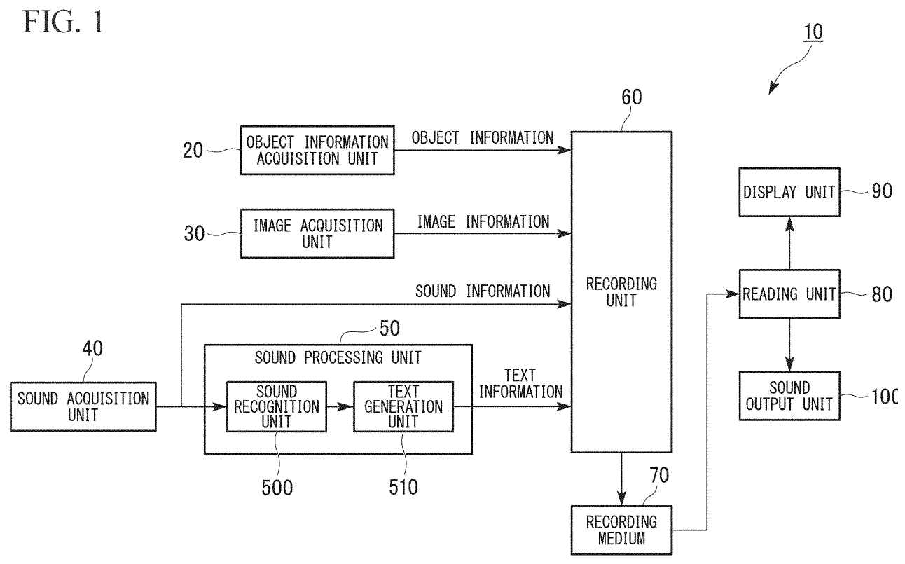

FIG. 1 shows a configuration of an information recording system 10 according to a first embodiment of the present invention. As shown in FIG. 1, the information recording system 10 includes an object information acquisition unit 20, an image acquisition unit 30, a sound acquisition unit 40, a sound processing unit 50, a recording unit 60, a recording medium 70, a reading unit 80, a display unit 90, and a sound output unit 100.

The object information acquisition unit 20 acquires object information about an object. The object is an object to be observed. The observation is an act of figuring out a state of the object. The observation may include acts such as diagnosis, an examination, and an inspection. The object information acquired for observation may not be necessarily visual information of the outside or inside of the object, i.e., image information. For example, the object information acquisition unit 20 is a camera mounted on image devices such as a microscope, an endoscope, a thermal imaging device, an X-ray device, and a computed tomography (CT) device. These image devices acquire image information of the object. These image devices may include a camera that generates image information on the basis of a signal obtained from a sensor. The image information acquired by these image devices may be any one of moving-image information and still-image information. The object information acquisition unit 20 may be a sensor that acquires information such as a temperature, acceleration, pressure, a voltage, and a current of the object. When the object is a living thing, the object information acquisition unit 20 may be a vital sensor that acquires vital information of the object. For example, the vital information is information such as a body temperature, blood pressure, a pulse, an electrocardiogram, or a degree of blood oxygen saturation. The object information acquisition unit 20 may be a microphone that acquires sound information based on a sound uttered by the object. For example, the sound information is information of a hammering test sound, an echo sound, a heart sound, noise, and the like. Additional information such as time point information may be added to the object information acquired by the object information acquisition unit 20. For example, the object information acquisition unit 20 adds time point information indicating a time point at which the object information was acquired to the object information, and outputs the object information to which the time point information is added. When the object information is time-series information, time point information for identifying a plurality of different time points is added to the object information. For example, the time point information associated with the object information includes a time point at which acquisition of the object information was started and a sampling rate.

The image acquisition unit 30 acquires image information indicating a type of situation in which the object information was acquired. The image information acquired by the image acquisition unit 30 indicates a state of at least one of the object and surroundings of the object when the object information is acquired. That is, the image information acquired by the image acquisition unit 30 indicates an observation situation. The image acquisition unit 30 is an image device including a camera. The image acquisition unit 30 acquires the image information in parallel with the acquisition of the object information by the object information acquisition unit 20. The image information acquired by the image acquisition unit 30 may be any one of moving image-information and still-image information. For example, the image acquisition unit 30 acquires the image information including an image of the at least one of the object and the surroundings of the object. For example, the surroundings of the object include a device on which the object information acquisition unit 20 is mounted. In this case, image information including an image of at least one of the object and the device on which the object information acquisition unit 20 is mounted is acquired. The surroundings of the object may also include an observer who observes the object. In this case, image information including an image of at least one of the object and the observer is acquired. The image acquisition unit 30 is disposed such that at least one of the object and the surroundings of the object is included in a photographing range.

When the image information acquired by the image acquisition unit 30 includes an image of the object, the image information includes an image of a part or all of the object. When the image information acquired by the image acquisition unit 30 includes an image of the device on which the object information acquisition unit 20 is mounted, the image information includes an image of a part or all of the device. When the image information acquired by the image acquisition unit 30 includes an image of a user, the image information includes an image of a part or all of the user. When the object information acquisition unit 20 is an image device and the object information is an image of the object, a photographic visual field of the image acquisition unit 30 is wider than that of the object information acquisition unit 20. For example, the object information acquisition unit 20 acquires image information of a part of the object and the image acquisition unit 30 acquires image information of all of the object. The image acquisition unit 30 may be a wearable camera worn by the user, i.e., an observer. For example, the wearable camera is a head mount type camera mounted in the vicinity of the eyes of the observer such that image information corresponding to the viewpoint of the observer can be acquired. Therefore, the image acquisition unit 30 may be disposed at a position of the viewpoint of the observer who observes the object or in the vicinity of the viewpoint. Additional information such as time point information may be added to the image information acquired by the image acquisition unit 30. For example, the image acquisition unit 30 adds the time point information indicating a time point at which the image information was acquired to the image information and outputs the image information to which the time point information is added. When the image information is time-series information, time point information for identifying a plurality of different time points is added to the image information. For example, the time point information associated with the image information includes a time point at which acquisition of the image information was started and a sampling rate.

The sound acquisition unit 40 acquires sound information based on a sound uttered by the observer who observes the object. For example, the sound acquisition unit 40 is a microphone. The sound acquisition unit 40 may be a wearable microphone worn by the observer. The wearable microphone is worn in the vicinity of the observer's mouth. The sound acquisition unit 40 may be a microphone having directivity such that only the sound of the observer is acquired. In this case, the sound acquisition unit 40 may not be installed in the vicinity of the observer's mouth. Thereby, a degree of freedom with respect to the disposition of the sound acquisition unit 40 is obtained. Because noise other than the sound of the observer is eliminated, the efficiency in generation and retrieval of text information is improved. In parallel with the acquisition of the object information by the object information acquisition unit 20, the sound acquisition unit 40 acquires sound information. Additional information such as time point information may be added to the sound information acquired by the sound acquisition unit 40. For example, the sound acquisition unit 40 adds the time point information indicating a time point at which the sound information was acquired to the sound information and outputs the sound information to which the time point information is added. When the sound information is time-series information, the time point information for identifying a plurality of different time points is added to the sound information. For example, the time point information associated with the sound information includes a time point at which acquisition of the sound information was started and a sampling rate.

The sound processing unit 50 converts the sound information acquired by the sound acquisition unit 40 into text information. For example, the sound processing unit 50 includes a sound processing circuit that performs sound processing. The sound processing unit 50 includes a sound recognition unit 500 and a text generation unit 510. The sound recognition unit 500 recognizes a sound of the user, i.e., the observer, on the basis of the sound information acquired by the sound acquisition unit 40. The text generation unit 510 generates text information corresponding to the user's sound by converting the sound recognized by the sound recognition unit 500 into the text information. The text generation unit 510 may divide consecutive sounds into appropriate blocks and generate text information for each block. Additional information such as time point information may be added to the text information generated by the sound processing unit 50. For example, the sound processing unit 50 (the text generation unit 510) adds the time point information indicating a time point at which the text information was generated to the text information and outputs the text information to which the time point information is added. When the text information is time-series information, the time point information corresponding to a plurality of different time points is added to the text information. A time point of the text information corresponds to a start time point of the sound information associated with the text information.

The object information acquired by the object information acquisition unit 20, the image information acquired by the image acquisition unit 30, the sound information acquired by the sound acquisition unit 40, and the text information generated by the sound processing unit 50 are input to the recording unit 60. The recording unit 60 records the object information, the image information, the sound information, and the text information on the recording medium 70 such that the object information, the image information, the sound information, and the text information are associated with each other. At this time, the recording unit 60 associates the object information, the image information, the sound information, and the text information with each other on the basis of the time point information. For example, the recording unit 60 includes a recording processing circuit that performs an information recording process. At least one piece of the object information, the image information, the sound information, and the text information may be compressed. Therefore, the recording unit 60 may include a compression processing circuit for compressing information. The recording unit 60 may include a buffer for the recording process and the compression process.

The object information, the image information, the sound information, and the text information are associated with each other as information about a common object. The object information, the image information, the sound information, and the text information may be associated with each other as information about a plurality of objects related to each other. For example, each piece of the object information, the image information, the sound information, and the text information includes one file and the recording unit 60 records each file on the recording medium 70. In this case, information for associating files of the object information, the image information, the sound information, and the text information is recorded on the recording medium 70. The recording unit 60 may record the object information, the image information, the sound information, the text information, and time point information on the recording medium 70 such that the object information, the image information, the sound information, the text information, and the time point information are associated with each other. The time point information indicates time points at which the object information, the image information, and the sound information were acquired. The time point information associated with the text information indicates the time point at which the sound information that is a source of the text information was acquired. For example, the time point information is added to each piece of the object information, the image information, the sound information, and the text information. The object information, the image information, the sound information, and the text information are associated with each other via the time point information.

The recording medium 70 is a nonvolatile storage device. For example, the recording medium 70 is at least one of an erasable programmable read only memory (EPROM), an electrically erasable programmable read-only memory (EEPROM), a flash memory, and a hard disk drive. The recording medium 70 may not be disposed at an observation site. For example, the information recording system 10 may have a network interface and the information recording system 10 may be connected to the recording medium 70 via a network such as the Internet or a local area network (LAN). The information recording system 10 may have a wireless communication interface and the information recording system 10 may be connected to the recording medium 70 through wireless communication according to a standard such as Wi-Fi (registered trademark) or Bluetooth (registered trademark). Therefore, the information recording system 10 may not directly include the recording medium 70.

The reading unit 80 reads the object information, the image information, the sound information, and the text information from the recording medium 70. Thereby, the reading unit 80 reproduces the object information, the image information, the sound information, and the text information recorded on the recording medium 70. For example, the reading unit 80 includes a reading processing circuit that performs an information reading process. At least one piece of the object information, the image information, the sound information, and the text information recorded on the recording medium 70 may be compressed. Therefore, the reading unit 80 may include a decompression processing circuit for decompressing the compressed information. The reading unit 80 may include a buffer for a reading process and a decompression process. When the time point information is recorded on the recording medium 70, the reading unit 80 reads the object information, the image information, the sound information, and the text information associated with each other from the recording medium 70 on the basis of the time point information. The reading unit 80 causes the reading of the object information, the image information, the sound information, and the text information to be synchronized on the basis of the time point information. For example, the reading unit 80 reads the object information, the image information, the sound information, and the text information associated with the same time point information. When pieces of time point information associated with the information are not synchronized with each other, the reading unit 80 may read the information in consideration of a difference in the time point information with respect to a reference time point.

The display unit 90 displays the object information, the image information, and the text information read by the reading unit 80 such that the object information, the image information, and the text information are associated with each other. The display unit 90 is a display device such as a liquid crystal display. For example, the display unit 90 is a monitor of a personal computer (PC). The display unit 90 may be a wearable display such as smart glasses worn by the user. The display unit 90 may be a display unit of a device on which the object information acquisition unit 20 is mounted. The display unit 90 may be a large-size monitor for sharing information. The display unit 90 may be a touch panel display. For example, the display unit 90 simultaneously displays the object information, the image information, and the text information. At this time, the display unit 90 displays the object information, the image information, and the text information in a state in which these pieces of information are arranged. When the object information, the image information, the text information, and the time point information are associated with each other, the reading unit 80 reads the object information, the image information, and the text information such that the object information, the image information, and the text information are synchronized with each other. Thus, the display unit 90 displays the object information, the image information, and the text information such that the object information, the image information, and the text information are synchronized with each other. Information selected from the object information, the image information, and the text information may be displayed on the display unit 90 and the user may be able to switch the information that is displayed on the display unit 90. For example, the object information acquired by the sensor or the vital sensor includes time-series sensor signals. For example, the display unit 90 displays a waveform of a sensor signal as a graph.

The display unit 90 may visually display the sound information read by the reading unit 80 as character information or a chart. In this case, the display unit 90 displays the object information, the image information, the sound information, and the text information read by the reading unit 80 such that the object information, the image information, the sound information, and the text information are associated with each other. For example, the sound information includes time-series sound signals. For example, the display unit 90 displays a change in amplitude or power of the sound signal over time as a graph.

The sound output unit 100 outputs a sound based on the sound information read by the reading unit 80. For example, the sound output unit 100 is a speaker. When the object information, the image information, the sound information, the text information, and the time point information are associated with each other, the object information, the image information, the sound information, and the text information are read by the reading unit 80 in synchronization with each other. Thus, the sound output unit 100 outputs a sound in synchronization with the display of the information by the display unit 90.

When the object information acquired by the object information acquisition unit 20 is image information, the object information may be output to the display unit 90. The display unit 90 may display the object information in parallel with the acquisition of the object information by the object information acquisition unit 20. The image information acquired by the image acquisition unit 30 may be output to the display unit 90. The display unit 90 may display the image information acquired by the image acquisition unit 30 in parallel with the acquisition of the object information by the object information acquisition unit 20. Thereby, the user can figure out a state of the object and an observation situation in real time.

The sound processing unit 50, the recording unit 60, and the reading unit 80 may include one or more processors. For example, the processor is at least one of a central processing unit (CPU), a digital signal processor (DSP), and a graphics processing unit (GPU). The sound processing unit 50, the recording unit 60, and the reading unit 80 may include an application specific integrated circuit (ASIC) or a field-programmable gate array (FPGA).

In the information recording system 10, the sound acquisition and recording are optional. Therefore, the information recording system 10 may not include the sound acquisition unit 40, the sound processing unit 50, and the sound output unit 100. In this case, the recording unit 60 records the object information and the image information on the recording medium 70 such that the object information and the image information are associated with each other. The reading unit 80 reads the object information and the image information from the recording medium 70. The display unit 90 displays the object information and the image information read by the reading unit 80 such that the object information and the image information are associated with each other.

The information recording system 10 may not include the sound output unit 100 and the recording unit 60 may not record the sound information. In this case, the recording unit 60 records the object information, the image information, and the text information on the recording medium 70 such that the object information, the image information, and the text information are associated with each other. The reading unit 80 reads the object information, the image information, and the text information from the recording medium 70. The display unit 90 displays the object information, the image information, and the text information read by the reading unit 80 such that the object information, the image information, and the text information are associated with each other.

The information recording system 10 may not include the sound processing unit 50. In this case, the recording unit 60 records the object information, the image information, and the sound information on the recording medium 70 such that the object information, the image information, and the sound information are associated with each other. The reading unit 80 reads the object information, the image information, and the sound information from the recording medium 70. The display unit 90 displays the object information and the image information read by the reading unit 80 such that the object information and the image information are associated with each other. The sound output unit 100 outputs a sound based on the sound information read by the reading unit 80.

The information recording system 10 may include an operation unit that accepts an operation by the user. For example, the operation unit is configured to include at least one of a button, a switch, a key, a mouse, a joystick, a touch pad, a track ball, and a touch panel.

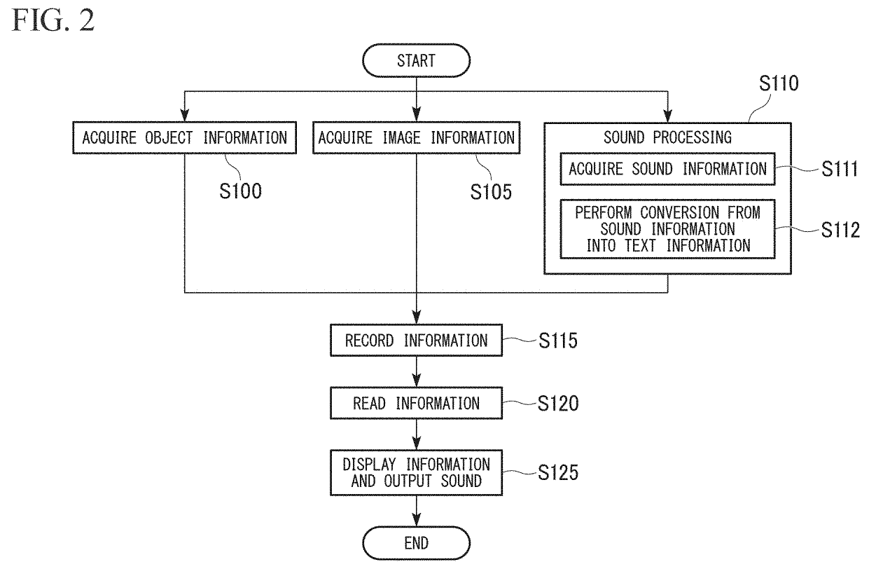

FIG. 2 show, a procedure of processing of the information recording system 10. The procedure of processing of the information recording system 10 will be described with reference to FIG. 2.

The object information acquisition unit 20 acquires object information about an object (step S100 (an object information acquisition step)). The object information acquired in step S100 is stored in the buffer within the recording unit 60. In parallel with the acquisition of the object information by the object information acquisition unit 20, the image acquisition unit 30 acquires image information indicating a type of situation in which the object information was acquired (step S105 (an image acquisition step)). The image information acquired in step S105 is stored in the buffer within the recording unit 60. In parallel with the acquisition of the object information by the object information acquisition unit 20, the processing in step S110 is performed. Step S110 includes step S111 (a sound acquisition step) and step S112 (a sound processing step). In step S111, the sound acquisition unit 40 acquires sound information based on a sound uttered by the observer who observes the object. In step S112, the sound processing unit 50 converts the sound information acquired by the sound acquisition unit 40 into text information. In step S110, the processing in step S111 and step S112 is iterated. The sound information acquired in step S111 and the text information generated in step S112 are stored in the buffer within the recording unit 60.

Processing start timings of step S100, step S105, and step S110 may not be the same. Processing end timings of step S100, step S105, and step S110 may not be the same. At least some of periods during which the processing in step S100, step S105, and step S110 is performed overlap each other.

After the acquisition of the object information, the image information, and the sound information is completed, the recording unit 60 records the object information, the image information, the sound information, and the text information stored in the buffer within the recording unit 60 on the recording medium 70 such that the object information, the image information, the sound information, and the text information are associated with each other (step S115 (a recording step)).

After step S115, the reading unit 80 reads the object information, the image information, the sound information, and the text information from the recording medium 70 (step S120 (a reading step)). The user may be able to specify a timing at which the information is read.

After step S120, the display unit 90 displays the object information, the image information, and the text information read by the reading unit 80 such that the object information, the image information, and the text information are associated with each other. Also, the sound output unit 100 outputs a sound based on the sound information read by the reading unit 80 (step S125 (a display step and a sound output step)).

When the information recording system 10 does not include the sound acquisition unit 40, the sound processing unit 50, and the sound output unit 100, the processing in step S110 is not performed. Also, in step S115, the recording unit 60 records the object information and the image information on the recording medium 70 such that the object information and the image information are associated with each other.

In step S120, the reading unit 80 reads the object information and the image information from the recording medium 70. In step S125, the display unit 90 displays the object information and the image information read by the reading unit 80 in step S120 such that the object information and the image information are associated with each other.

When the information recording system 10 does not include the sound output unit 100 and the recording unit 60 does not record the sound information, the recording unit 60 records the object information, the image information, and the text information on the recording medium 70 such that the object information, the image information, and the text information are associated with each other in step S115. In step S120, the reading unit 80 reads the object information, the image information, and the text information from the recording medium 70. In step S125, the display unit 90 displays the object information, the image information, and the text information read by the reading unit 80 in step S120 such that the object information, the image information, and the text information are associated with each other.

When the information recording system 10 does not include the sound processing unit 50, the processing in step S112 is not performed. Also, in step S115, the recording unit 60 records the object information, the image information, and the sound information on the recording medium 70 such that the object information, the image information, and the sound information are associated with each other. In step S120, the reading unit 80 reads the object information, the image information, and the sound information from the recording medium 70. In step S125, the display unit 90 displays the object information and the image information read by the reading unit 80 in step S120 such that the object information and the image information are associated with each other. Also, in step S125, the sound output unit 100 outputs a sound based on the sound information read by the reading unit 80 in step S120.

As described above, the object information is acquired by the object information acquisition unit 20 and the image acquisition unit 30 acquires the image information indicating a type of situation in which the object information was acquired. The acquired object information and image information are recorded on the recording medium 70 by the recording unit 60. Thereby, the information recording system 10 can record visual information indicating a type of situation in which the object information was acquired.

In the above-described method, a burden on the user for recording the information indicating a type of situation in which the object information was acquired is small. Even when the user cannot use his/her hand, necessary information can be recorded and omissions in recording or erroneous recording are reduced. Therefore, the information recording system 10 can accurately and efficiently leave a record showing the type of situation in which the object information was acquired.

In the above-described method, the user's comments when the object information was acquired are recorded as a sound and text corresponding to the sound is recorded in association with the object information and the image information. A “tag” based on the text is attached to the object information, the image information, and the sound information and therefore browsability and searchability of the information are improved. Also, the user can easily understand a situation when the information was acquired.

A specific example of the information recording system 10 will be described below.

(Observation with Microscope)

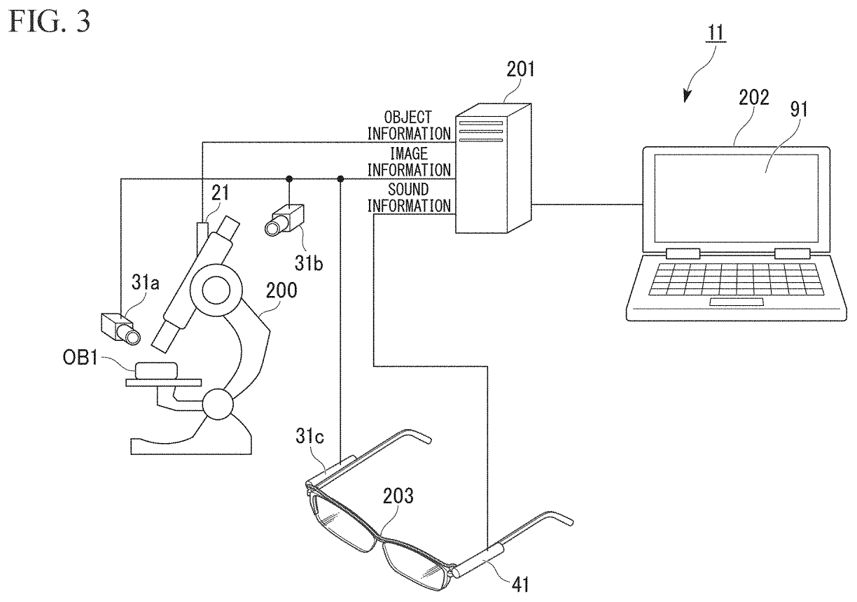

FIG. 3 shows a schematic configuration of a microscope system 11 which is an example of the information recording system 10. As shown in FIG. 3, the microscope system 11 includes a microscope 200, a camera 31a, a camera 31b, a camera 31c, a microphone 41, a server 201, and a PC 202.

The microscope 200 is a device for enlarging and observing an object OB1. The camera 21 connected to the microscope 200 constitutes the object information acquisition unit 20. The camera 21 acquires image information of the object OB1 enlarged by the microscope 200 as object information. For example, the camera 21 acquires moving-image information.

The camera 31a, the camera 31b, and the camera 31c constitute the image acquisition unit 30. A photographic visual field of each of the camera 31a, the camera 31b, and the camera 31c is wider than that of the camera connected to the microscope 200. For example, the camera 31a, the camera 31b, and the camera 31c acquire moving-image information.

The camera 31a is disposed in the vicinity of a tip of an objective lens of the microscope 200. The camera 31a acquires image information including an image of the object OB1 and the tip of the objective lens of the microscope 200 by photographing the vicinity of the tip of the objective lens of the microscope 200. Thereby, a positional relationship between the object OB1 and the tip of the objective lens of the microscope 200 is recorded as image information. The user who is the observer does not need to approach the object OB1 and the tip of the objective lens of the microscope 200 to check states thereof. By viewing the image information acquired by the camera 31a, the user can easily figure out a situation such as which part of the object OB1 is being observed or how close the objective lens tip of the microscope 200 is to the object OB1.

The camera 31b is disposed in an indoor space where observation is performed. The camera 31b acquires image information including an image of all of the object OB1 and the microscope 200 by photographing all of the object OB1 and the microscope 200. Thereby, all situations of an observation site are recorded as the image information. By viewing the image information acquired by the camera 31b, the user can easily figure out a situation such as an event occurring in a portion different from a portion to which the user is paying attention. When the object OB1 is a living thing, the state of the object OB1 is likely to affect the object information obtained by observation. For example, even when it is difficult to determine a state related to death and life of the object OB1 from the object information, the user can easily figure out the state of the object OB1 by viewing the image information acquired by the camera 31b. The camera 31b may acquire image information including an image of the user.

The camera 31c is configured as a wearable camera. The camera 31c is configured as the wearable camera by being attached to an accessory 203 capable of being attached to the user's head. When the user wears the accessory 203, the camera 31c is disposed at a position near a viewpoint of the user. The camera 31c acquires image information including an image of the object OB1 and the microscope 200 by photographing the object OB1 and the microscope 200. Alternatively, the camera 31c acquires image information including an image of the microscope 200 without including an image of the object OB1 by photographing the microscope 200. Thereby, an observation situation corresponding to a part to which the user is paying attention in observation is recorded as the image information. Thereby, the microscope system 11 can record observation states such as a situation before the object OB1 is set up on a microscope stage, a procedure of adjusting the microscope 200, and an adjustment state of the microscope 200. The user, other people, and the like can easily figure out a situation during the observation in real time or after the end of observation by viewing the recorded observation states.

The microphone 41 constitutes the sound acquisition unit 40. The microphone 41 is configured as a wearable microphone by being attached to the accessory 203.

The server 201 includes the sound processing unit 50, the recording unit 60, the recording medium 70, and the reading unit 80. The object information acquired by the camera 21, the image information acquired by the camera 31a, the camera 31b and the camera 31c, and the sound information acquired by the microphone 41 are input to the server 201.

The PC 202 is connected to the server 201. The screen 91 of the PC 202 constitutes the display unit 90. The smart glasses may constitute the display unit 90. In parallel with the acquisition of the object information, the smart glasses may display the image information that is the object information and the image information acquired by each of the camera 31a, the camera 31b, and the camera 31c. By wearing the smart glasses, the user can figure out the state of the object OB1 and the observation situation in real time.

The information recording system 10 may be applied to a microscope system using a multiphoton excitation fluorescence microscope. The multiphoton excitation fluorescence microscope is used within a dark room. A camera connected to the multiphoton excitation fluorescence microscope constitutes the object information acquisition unit 20. For example, as infrared cameras, the camera 31a, the camera 31b, and the camera 31c constitute the image acquisition unit 30. The infrared camera acquires image information including an image of all of the object and the multiphoton excitation fluorescence microscope by photographing all of the object and the multiphoton excitation fluorescence microscope. For example, the user who is an observer wears a wearable microphone constituting the sound acquisition unit 40. A device such as a PC includes the sound processing unit 50, the recording unit 60, the recording medium 70, and the reading unit 80. The object information acquired by the camera connected to the multiphoton excitation fluorescence microscope, the image information acquired by the infrared camera, and the sound information acquired by the wearable microphone are input to the device. The screen of the device constitutes the display unit 90.

In a dark environment, it is difficult for the user to figure out the state of the microscope and the situation of the experiment and write the state and the situation that have been figured out on paper with the user's hand. In a system to which the information recording system 10 is applied, the user does not need to stop the experiment and turn on a light in order to know the state of the microscope and the situation of the experiment. Also, the user does not need to temporarily stop the microscope and look into the dark room. Also, the user does not need to manually write the state of the microscope and the situation of the experiment on paper with his/her hand.

(Inspection with Endoscope)

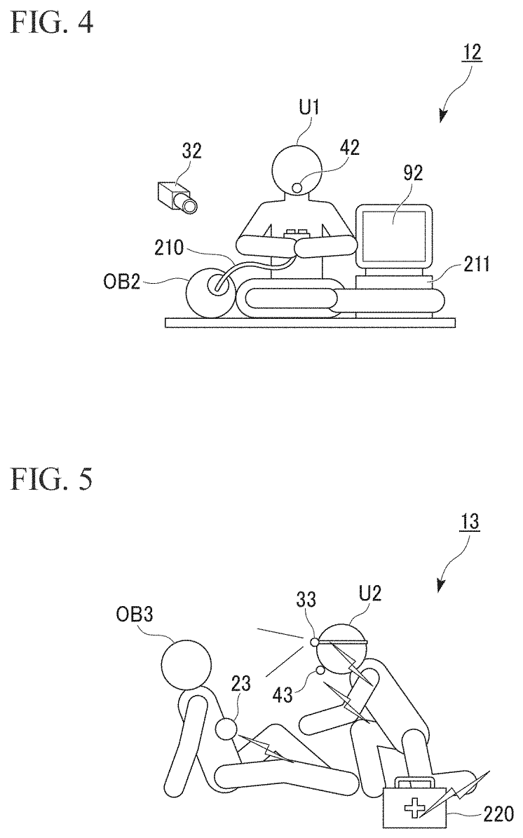

FIG. 4 shows a schematic configuration of the endoscope system 12 which is an example of the information recording system 10. As shown in FIG. 4, the endoscope system 12 includes an endoscope 210, a camera 32, a microphone 42, and a PC 211.

The endoscope 210 is inserted into an object OB2. The object OB2 is a person who is undergoing an endoscopic inspection, i.e., a patient. The endoscope 210 is a device for observing the inside of the object OB2. A camera disposed on a tip of the endoscope 210 constitutes the object information acquisition unit 20. This camera acquires image information of the inside of the body of the object OB2 as object information. For example, this camera acquires moving-image information and still-image information.

The camera 32 constitutes the image acquisition unit 30. The camera 32 is disposed within an indoor space where an inspection is performed. For example, the camera 32 acquires moving-image information including an image of the object OB2 and the endoscope 210 as image information by photographing the object OB2 and the endoscope 210. Thereby, a situation of the inspection is recorded as image information. The camera 32 may acquire the image information including an image of a user U1. For example, the user U1 is a doctor. Thereby, the endoscope system 12 can record inspection states such as a procedure and method of inserting the endoscope 210, the motion of the object OB2, the motion of the user U1, and the like. The user U1, another doctor, an assistant, and the like can easily figure out a situation during the inspection in real time or after the end of the inspection by viewing the recorded inspection states.

The microphone 42 constitutes the sound acquisition unit 40. The microphone 42 is attached to the user U1 as a wearable microphone. The user U1 utters comments simultaneously with the inspection with the endoscope 210. The comments uttered by the user U1 are recorded in association with the object information and the image information. Thus, the user U1 can efficiently create an accurate inspection record to be used for the purpose of creating findings, materials for conference presentation, educational content for less experienced doctors, and the like.

The PC 211 includes the sound processing unit 50, the recording unit 60, the recording medium 70, and the reading unit 80. The object information acquired by the camera disposed at the tip of the endoscope 210, the image information acquired by the camera 32, and the sound information acquired by the microphone 42 are input to the PC 211. A screen 92 of the PC 211 constitutes the display unit 90.

### (Examination at Emergency Site)

FIG. 5 shows a schematic configuration of an examination system 13 which is an example of the information recording system 10. As shown in FIG. 5, the examination system 13 includes a vital sensor 23, a camera 33, a microphone 43, and a device 220.

The vital sensor 23 is attached to an object OB3. The object OB3 is a person to be examined, i.e., a patient. The vital sensor 23 constitutes the object information acquisition unit 20. The vital sensor 23 acquires biological information such as a body temperature, blood pressure, and a pulse of the object OB3 as object information.

The camera 33 constitutes the image acquisition unit 30. As a wearable camera, the camera 33 is attached to a user U2. For example, the camera 33 acquires moving-image information. The camera 33 acquires image information including an image of on-site situations of the object OB3, the hands of the user U2, and the like by photographing the on-site situations of the object OB3, the hands of the user U2, and the like. Thereby, a site, a condition of a patient, an examination situation, and the like are recorded as the image information. For example, the user U2 is a doctor or an emergency crew member. Thereby, the examination system 13 can record situations such as an examination procedure, details of a treatment on the object OB3, and a state of the object OB3. The user U2 and other doctors can easily figure out the site, the condition of the patient, the examination situation and the like in real time or after the end of the examination by viewing the recorded situations.

The microphone 43 constitutes the sound acquisition unit 40. As a wearable microphone, the microphone 43 is attached to the user U2. The user U2 utters comments simultaneously with the acquisition of the object information by the vital sensor 23. The comments uttered by the user U2 are recorded in association with the object information and the image information. Thus, the user U2 can efficiently and accurately deliver findings on the site with respect to the object OB3 to people such as other doctors.

The device 220 includes the sound processing unit 50, the recording unit 60, the recording medium 70, and the reading unit 80. The object information acquired by the vital sensor 23, the image information acquired by the camera 33, and the sound information acquired by the microphone 43 are input to the device 220. The information is wirelessly transmitted to the device 220. The device 220 wirelessly receives the information. The screen of the device 220 constitutes the display unit 90. The device 220 may wirelessly transmit the input information to the server. For example, the server includes the sound processing unit 50, the recording unit 60, the recording medium 70, and the reading unit 80. A doctor in a hospital can easily figure out the state of the patient by viewing the information received by the server.

### (Non-Destructive Inspection)

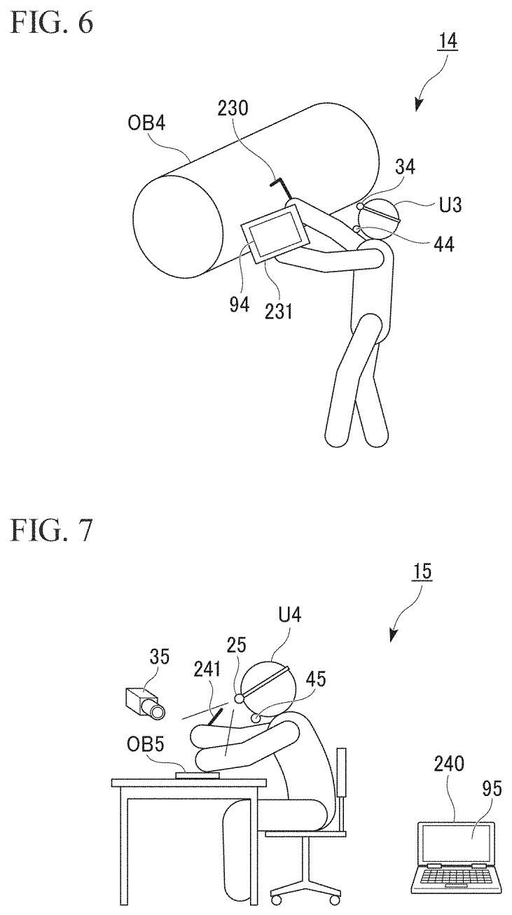

FIG. 6 shows a schematic configuration of an inspection system 14 which is an example of the information recording system 10. As shown in FIG. 6, the inspection system 14 includes a probe 230, a camera 34, a microphone 44, and a device 231.

The probe 230 constitutes the object information acquisition unit 20. The probe 230 acquires a signal such as an electric current corresponding to a defect on a surface of an object OB4 as object information. The object OB4 is an industrial product to be inspected. For example, the object OB4 is a plant pipe or an aircraft fuselage.

The camera 34 constitutes the image acquisition unit 30. As a wearable camera, the camera 34 is attached to a user U3. For example, the camera 34 acquires moving-image information. The camera 34 acquires image information including an image of the object OB4 and the probe 230 by photographing the object OB4 and the probe 230. Thereby, the situation of the non-destructive inspection is recorded as the image information. For example, the user U3 is an inspector. Thereby, the inspection system 14 can record inspection situations such as an inspection position and an inspection procedure in the object OB4. The user U3, other technicians, and the like can easily figure out a situation during the inspection in real time or after the end of the inspection by viewing the recorded inspection situations.

The microphone 44 constitutes the sound acquisition unit 40. As a wearable microphone, the microphone 44 is attached to the user U3. The user U3 utters comments simultaneously with the acquisition of the object information by the probe 230. The comments uttered by the user U3 are recorded in association with the object information and the image information. Thus, the user U3 can accurately and efficiently create a work report concerning the inspection of the object OB4.

The device 231 includes the sound processing unit 50, the recording unit 60, the recording medium 70, and the reading unit 80. The object information acquired by the probe 230, the image information acquired by the camera 34, and the sound information acquired by the microphone 44 are input to the device 231. A screen 94 of the device 231 constitutes the display unit 90. The device 231 may wirelessly transmit the information to the server. For example, the server includes the sound processing unit 50, the recording unit 60, the recording medium 70, and the reading unit 80. A technician who is away from the site can easily figure out the state of the inspection by viewing the information received by the server. Also, the user U3 can receive an instruction from the technician at a remote place by receiving information transmitted from the technician through the device 231 or another reception device.

The information recording system 10 may be applied to an inspection system using an industrial endoscope. Industrial endoscopes acquire image information of objects such as scratches and corrosion inside objects such as boilers, turbines, engines, and chemical plants. The scope constitutes the object information acquisition unit 20. For example, a user who is an inspector wears the wearable camera constituting the image acquisition unit 30 and the wearable microphone constituting the sound acquisition unit 40. A main body of the endoscope has the sound processing unit 50, the recording unit 60, the recording medium 70, and the reading unit 80. Object information acquired by the scope, image information acquired by the wearable camera, and sound information acquired by the wearable microphone are input to the main body. A screen of the main body constitutes the display unit 90.

### (Work Recording System)

FIG. 7 shows a schematic configuration of a work recording system 15 which is an example of the information recording system 10. As shown in FIG. 7, the work recording system 15 has a camera 25, a camera 35, a microphone 45, and a PC 240.

The camera 25 constitutes the object information acquisition unit 20. As a wearable camera, the camera 25 is attached to a user U4. The camera 25 acquires image information of an object OB5 as object information. For example, the camera 25 acquires moving-image information. For example, the user U4 is an operator. For example, the object OB5 is a circuit board.

The camera 35 constitutes the image acquisition unit 30. The camera 35 is disposed in an indoor space where work such as repair or assembly of the object OB5 is performed. A visual field of the camera 35 is wider than a visual field of the camera 25. For example, the camera 35 acquires moving-image information. The camera 35 acquires image information including an image of the object OB5 and a tool 241 by photographing the object OB5 and the tool 241 used by the user U4. Thereby, the situation of the work is recorded as the image information. Thereby, the work recording system 15 can record situations such as a work position and a work procedure in the object OB5. The user U4, other technicians, and the like can easily figure out the situation during work in real time or after the end of the work by viewing the recorded situations.

The microphone 45 constitutes the sound acquisition unit 40. As a wearable microphone, the microphone 45 is attached to the user U4. The user U4 utters comments simultaneously with the acquisition of the object information by the camera 25. The comments uttered by the user U4 are recorded in association with the object information and the image information. Thus, the user U4 can efficiently create an accurate work record to be used for the purpose of creating a work report related to work with respect to the object OB5 and educational content for less experienced workers. Also, the user U4 can easily trace work on the basis of a work history when a problem or the like occurs by storing the work record as the work history with respect to the object.

The PC 240 includes the sound processing unit 50, the recording unit 60, the recording medium 70, and the reading unit 80. The object information acquired by the camera 25, the image information acquired by the camera 35, and the sound information acquired by the microphone 45 are input to the PC 240 in a wireless manner or a wired manner (not shown). A screen 95 of the PC 240 constitutes the display unit 90.

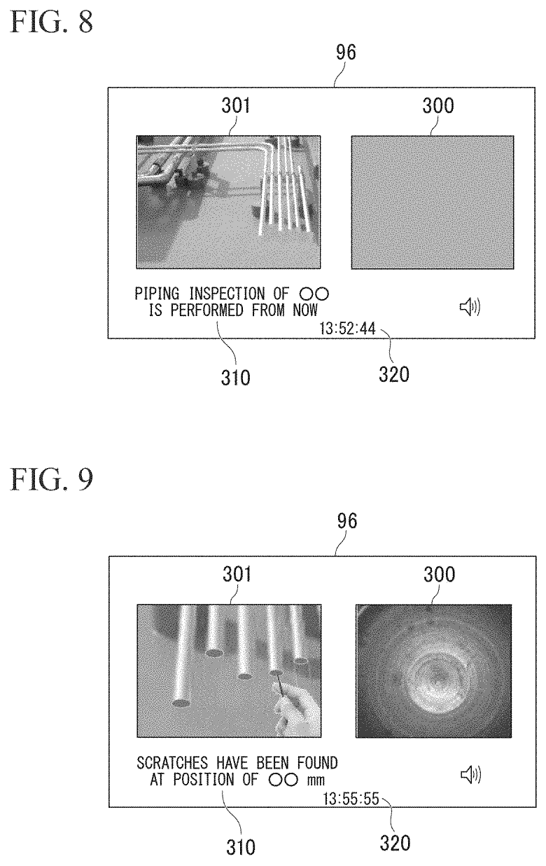

A specific example in which the information is displayed by the display unit 90 will be described below. FIGS. 8 and 9 show a screen 96 of the display unit 90.

Object information, image information, text information 310, and time point information 320 associated with the same object are displayed on the screen 96. The object information is displayed in a region 300 of the screen 96 and the image information is displayed in a region 301 of the screen 96. In this example, the information in a piping inspection is displayed. In this example, the object information is image information of the object acquired by a scope. Also, in this example, the image information is image information of the object and its surroundings acquired by the wearable camera worn by the user who is the inspector. The object information and the image information are moving-image information. In addition to the information shown in FIG. 8 and FIG. 9, information for identifying an inspection name, an inspector, an inspection object, and a date and the like may be displayed. For example, image information including an image of an inspection signboard with the information may be displayed. In FIG. 8, the information is displayed immediately before the start of the piping inspection. Before the piping inspection is started, no object information is acquired. Thus, no object information is displayed in the region 300. A sound based on the sound information is output by the sound output unit 100 in synchronization with the display of the information. The text information 310 corresponds to the sound.

In FIG. 9, the information is displayed after the piping inspection is started. After the piping inspection is started, the object information is displayed in the region 300 in addition to the image information, the text information 310, and the time point information 320. The information is synchronized and updated on the basis of the time point information. The display of the information may be performed by any of skip, fast forward, or frame advance.

### First Modified Example of First Embodiment

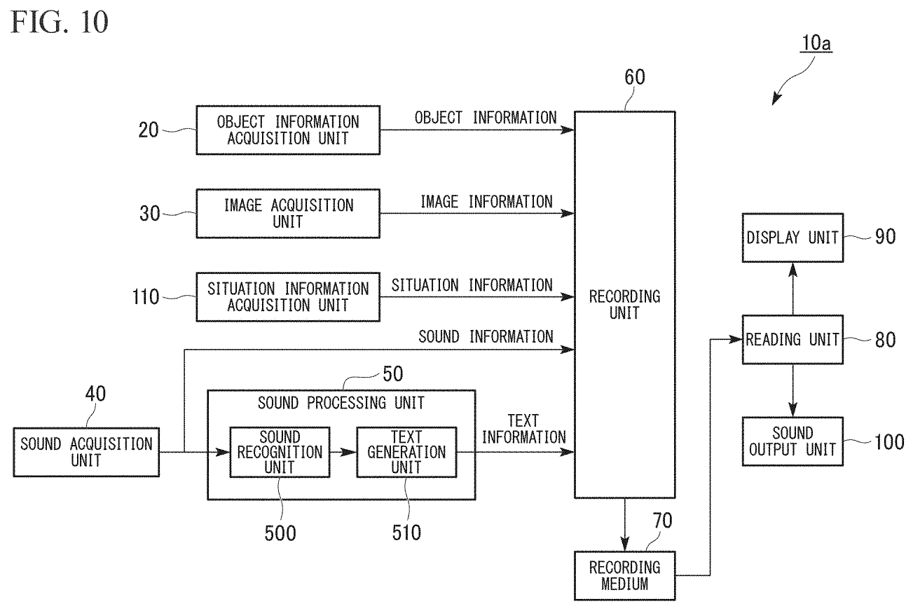

FIG. 10 shows a configuration of an information recording system 10a according to a first modified example of the first embodiment of the present invention. Differences from the configuration shown in FIG. 1 will be described with respect to the configuration shown in FIG. 10.

The information recording system 10a includes a situation information acquisition unit 110 in addition to the configuration of the information recording system 10 shown in FIG. 1. The situation information acquisition unit 110 acquires situation information that indicates a type of situation in which the object information was acquired and is information other than the image information of the object. For example, the situation information is information about at least one of a time point, a place, and a surrounding environment of the object. For example, the surrounding environment of the object indicates conditions such as a temperature, humidity, atmospheric pressure, and illuminance. When the situation information is time point information, the situation information acquisition unit 110 acquires the time point information from a device that generates the time point information. For example, the situation information acquisition unit 110 acquires the time point information from terminals such as a smartphone and a PC. When the situation information is place information, the situation information acquisition unit 110 acquires the place information from a device that generates the place information. For example, the situation information acquisition unit 110 acquires the place information from a terminal such as a smartphone equipped with a Global Positioning System (GPS) function. When the situation information is surrounding environment information, the situation information acquisition unit 110 acquires the surrounding environment information from a device that measures a surrounding environment value. For example, the situation information acquisition unit 110 acquires the surrounding environment information from sensors such as a thermometer, a hygrometer, a barometer, and a luminometer.

The situation information may be device information about a device including an object information acquisition unit 20. The device information may be setting values of the device. For example, in a multiphoton excitation fluorescence microscope, the set values of the device are values such as lens magnification, an amount of observation light, laser power, and a stage position. Additional information such as time point information may be added to the situation information other than the time point information acquired by the situation information acquisition unit 110. For example, the situation information acquisition unit 110 adds the time point information indicating a time point at which the situation information was acquired to the situation information and outputs the situation information to which the time point information is added. When the situation information is time-series information, time point information for identifying a plurality of different time points is added to the situation information. For example, the time point information associated with the situation information includes a time point at which the acquisition of the situation information was started and a sampling rate.

A recording unit 60 records the object information, the image information, the sound information, the text information, and the situation information on a recording medium 70 such that the object information, the image information, the sound information, the text information, and the situation information are associated with each other. The recording unit 60 may record the object information, the image information, the sound information, the text information, the situation information, and the time point information on the recording medium 70 such that the object information, the image information, the sound information, the text information, the situation information, and the time point information are associated with each other. The time point information indicates time points at which the object information, the image information, the sound information, the text information, and the situation information were acquired. The object information, the image information, the sound information, the text information, and the situation information are associated with each other via the time point information. The situation information may be compressed.

A reading unit 80 reads the object information, the image information, the sound information, the text information, and the situation information from the recording medium 70. A display unit 90 displays the object information, the image information, the text information, and the situation information read by the reading unit 80 such that the object information, the image information, the text information, and the situation information are associated with each other. For example, the display unit 90 simultaneously displays the object information, the image information, the text information, and the situation information. At this time, the display unit 90 displays the object information, the image information, the text information, and the situation information in a state in which these pieces of information are arranged. The information selected from the object information, the image information, the text information, and the situation information may be displayed on the display unit 90 and the user may be able to switch information to be displayed on the display unit 90.

In terms of points other than the above, the configuration shown in FIG. 10 is similar to the configuration shown in FIG. 1.

When the situation information is recorded, the information recording system 10a can also record other information as information indicating a type of situation in which the object information was acquired in addition to visual information. Thereby, the information recording system 10a can more accurately record an observation situation. Therefore, the user can more accurately reproduce and verify an accurate procedure.

### Second Modified Example of First Embodiment

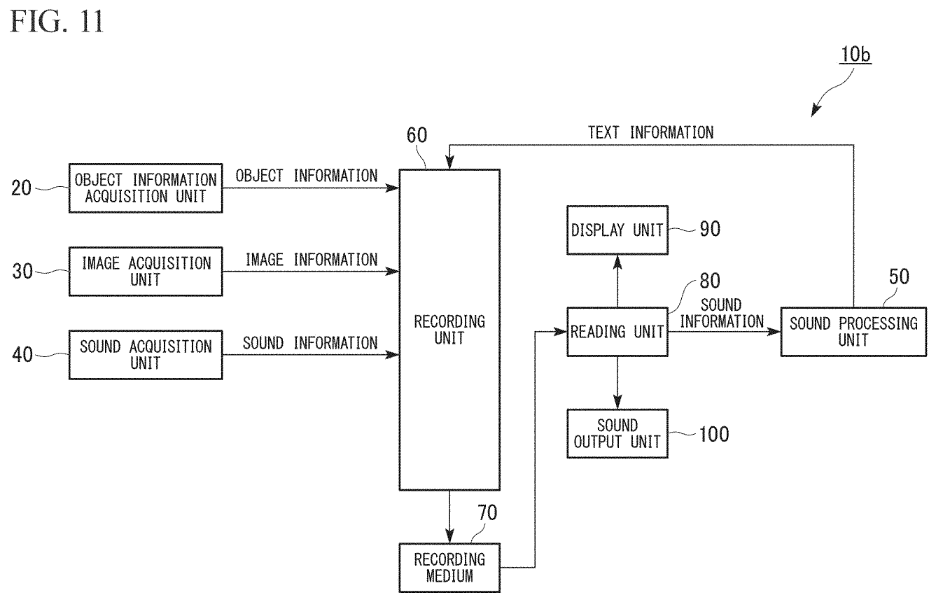

FIG. 11 shows a configuration of an information recording system 10b according to a second modified example of the first embodiment of the present invention. In terms of the configuration shown in FIG. 11, differences from the configuration shown in FIG. 1 will be described.

A recording unit 60 records object information, image information, and sound information on a recording medium 70 such that the object information, the image information, and the sound information are associated with each other. A reading unit 80 reads the sound information from the recording medium 70. A sound processing unit 50 converts the sound information read by the reading unit 80 into text information. The recording unit 60 associates the text information with the object information, the image information, and the sound information recorded on the recording medium 70, and records the text information on the recording medium 70.

In terms of points other than the above, the configuration shown in FIG. 11 is similar to the configuration shown in FIG. 1.

In the information recording system 10b, sound processing is performed by the sound processing unit 50 after the entire sound information is recorded on the recording medium 70. Generally, the load of sound processing is high. Even when a sound processing rate is slower than a sound information acquisition rate, the information recording system 10b can record the text information.

### Third Modified Example of First Embodiment

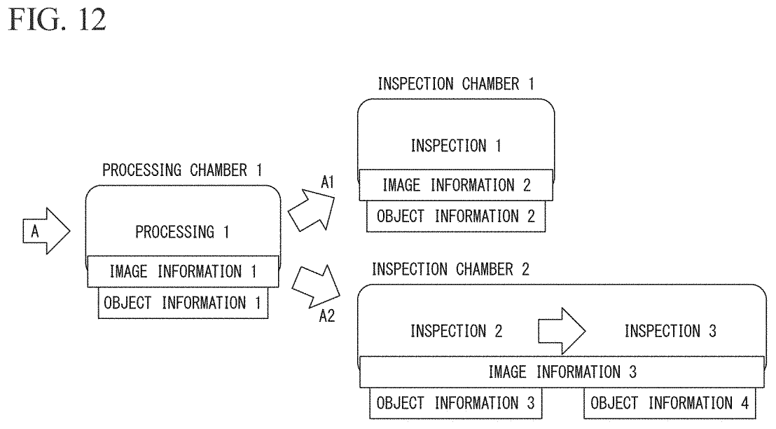

In a third modified example of the first embodiment of the present invention, a plurality of pieces of information of the same type are acquired. FIG. 12 shows a flow of processing and inspection with respect to an object.

Object A is carried into processing chamber 1 and processing 1 is performed on object A in processing chamber 1. At this time, object information 1 and image information 1 are acquired. Object information 1 is information about object A when processing 1 has been performed. Image information 1 is acquired by a camera disposed in processing chamber 1. After processing 1 is completed, object A1 obtained by the processing of object A is carried into inspection chamber 1 and object A2 obtained by the processing of object A is carried into inspection chamber 2. In inspection chamber 1, inspection 1 is performed on object A1. At this time, object information 2 and image information 2 are acquired. Object information 2 is information about object A1 when inspection 1 has been performed. Image information 2 is acquired by the camera disposed in inspection chamber 1. In inspection chamber 2, inspection 2 is performed on object A2. At this time, object information 3 and image information 3 are acquired. Object information 3 is information about object A2 when inspection 2 has been performed. Image information 3 is acquired by a camera disposed in inspection chamber 2. After inspection 2 is completed, inspection 3 is performed on object A2 in inspection chamber 2. At this time, object information 4 and image information 3 are acquired. Object information 4 is information about object A2 when inspection 3 has been performed. Image information 3 is continuously acquired in both inspection 2 and inspection 3. Inspection 1 on object A1 and inspection 2 on object A2 are performed in parallel.

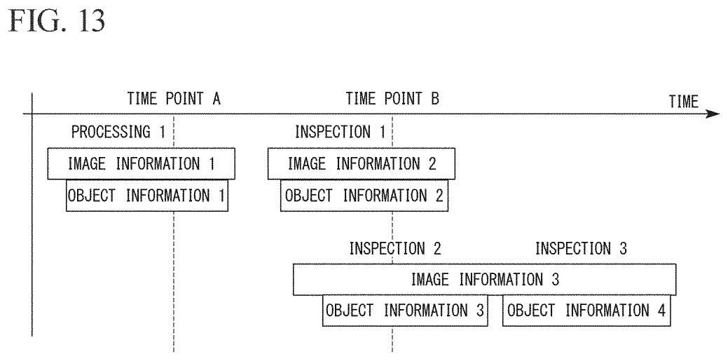

FIG. 13 shows timings at which the object information and the image information are acquired. The horizontal axis in FIG. 13 represents time. The information shown in FIG. 13 corresponds to the information shown in FIG. 12. In FIG. 13, the timings at which the information is acquired are shown.

In processing 1, object information 1 and image information 1 are acquired. Acquisition start timings of object information 1 and image information 1 may not be the same. Acquisition end timings of object information 1 and image information 1 may not be the same. A period during which object information 1 is acquired is included in a period during which image information 1 is acquired. In inspection 1, object information 2 and image information 2 are acquired. Acquisition start timings of object information 2 and image information 2 may not be the same. Acquisition end timings of object information 2 and image information 2 may not be the same. A period during which object information 2 is acquired is included in a period during which image information 2 is acquired.

In inspection 2 and inspection 3, object information 3, object information 4, and image information 3 are acquired. Acquisition start timings of object information 3, object information 4, and image information 3 may not be the same. Acquisition end timings of object information 3, object information 4, and image information 3 may not be the same. After object information 3 in inspection 2 is acquired, object information 4 corresponding to inspection 3 is acquired. A period during which object information 3 and object information 4 are acquired is included in a period during which image information 3 is acquired.

At time point A, object information 1 and image information 1 are acquired. Thus, object information 1 and image information 1 at time point A can be reproduced and displayed at the same time. At time point B, object information 2 and image information 2 are acquired. Also, at time point B, object information 3 and image information 3 are acquired. Thus, object information 2, object information 3, image information 2, and image information 3 at time point B can be reproduced and displayed at the same time.

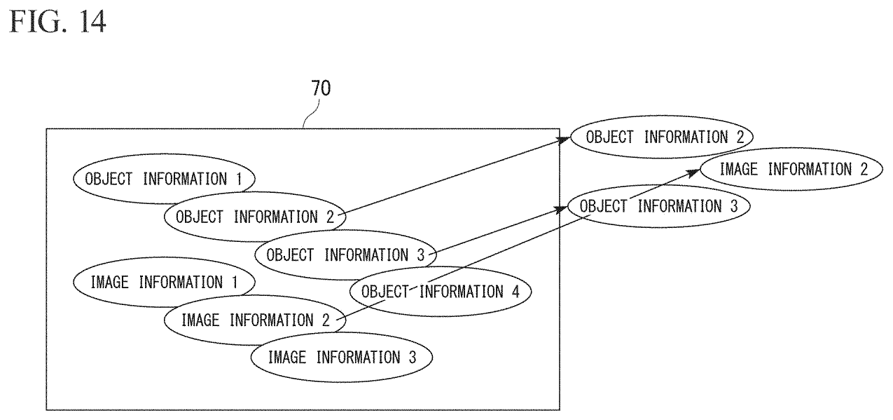

FIG. 14 shows object information and image information recorded on the recording medium 70. The information shown in FIG. 14 corresponds to the information shown in FIG. 12.

Object information 1, object information 2, object information 3, object information 4, image information 1, image information 2, and image information 3 are recorded on the recording medium 70. These pieces of information are associated with each other by object A, object A1, and object A2 related to each other. The association of the information may be specified by a user who is an observer. For example, when the user performs an operation of associating object information 2 and image information 2 with object information 1 and image information 1, these pieces of information may be associated with each other. Alternatively, when the user has performed an operation of associating object information 3, object information 4, and image information 3 with object information 1 and image information 1, these pieces of information may be associated with each other. The operation of associating the information is not limited to the above example.

The reading unit 80 reads any information from the recording medium 70 and the display unit 90 can display the information read by the reading unit 80. For example, as shown in FIG. 14, the reading unit 80 reads object information 2, object information 3, and image information 2. A user who is a viewer may perform an operation of specifying information to be read. When the operation of specifying the information to be read is performed by the user, the reading unit 80 reads the information specified by the user.

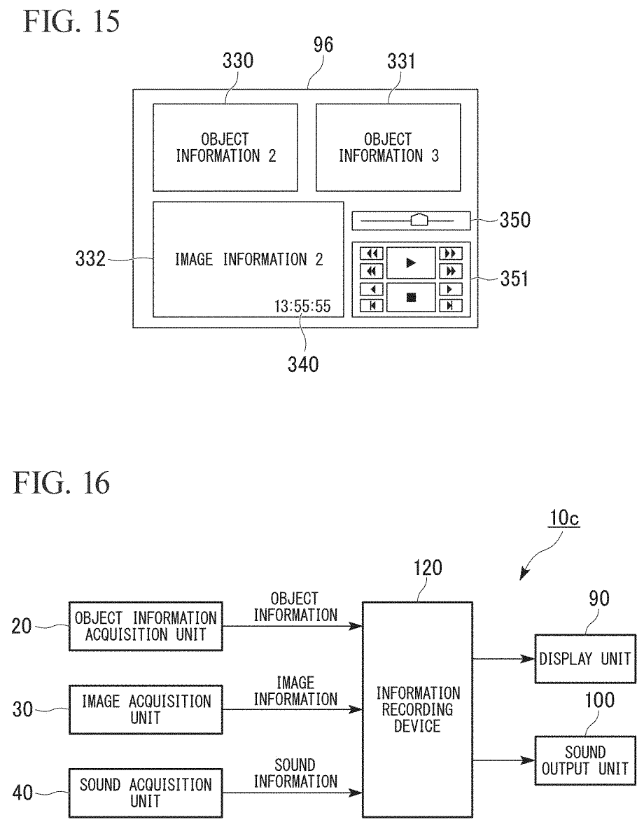

FIG. 15 shows a screen 96 of the display unit 90. As shown in FIG. 14, when object information 2, object information 3, and image information 2 are read from the recording medium 70, the information is displayed in the form shown in FIG. 15. Object information 2 is displayed in a region 330 of the screen 96 and object information 3 is displayed in a region 331 of the screen 96. Image information 2 is displayed in a region 332 of the screen 96. Time point information 340 is superimposed on image information 2. Object information 2, object information 3, and image information 2 are displayed in synchronization with each other. A display timing of the information is controlled on the basis of the time point information 340.

A user interface 350 and a user interface 351 for controlling the display timing of the information are displayed on the screen 96. The user interface 350 is configured as a slider bar. The user can specify any display timing by operating the user interface 350. The user interface 351 includes various buttons. By operating the user interface 351, the user can specify display methods such as display start, display stop, skip, fast forward, and frame advance.

FIGS. 12 to 15 relate to examples in which a plurality of pieces of information are acquired and displayed. A type of information to be acquired and displayed and an information display method are not limited to the above examples. In FIG. 15, at least one piece of text information, sound information, and situation information may be displayed in addition to the information shown in FIG. 15. A sound may be output by the sound output unit 100 in synchronization with the display of the information shown in FIG. 15.

As described above, the object information and the image information associated with each other are synchronized and displayed on the basis of the time point information. Thereby, the display unit 90 can synchronize and display a plurality of pieces of object information or a plurality of pieces of image information. Thus, the user can easily figure out details of a plurality of pieces of related information in time series.

### Second Embodiment

FIG. 16 shows a configuration of an information recording system 10c according to a second embodiment of the present invention. In terms of the configuration shown in FIG. 16, differences from the configuration shown in FIG. 1 will be described.

As shown in FIG. 16, the information recording system 10c includes an object information acquisition unit 20, an image acquisition unit 30, a sound acquisition unit 40, an information recording device 120, a display unit 90, and a sound output unit 100. Configurations of the object information acquisition unit 20, the image acquisition unit 30, the sound acquisition unit 40, the display unit 90, and the sound output unit 100 are similar to those corresponding to the components shown in FIG. 1. In the information recording system 10c shown in FIG. 16, the sound processing unit 50, the recording unit 60, the recording medium 70, and the reading unit 80 in the information recording system 10 shown in FIG. 1 are changed to the information recording device 120.

In terms of points other than the above, the configuration shown in FIG. 16 is similar to the configuration shown in FIG. 1.

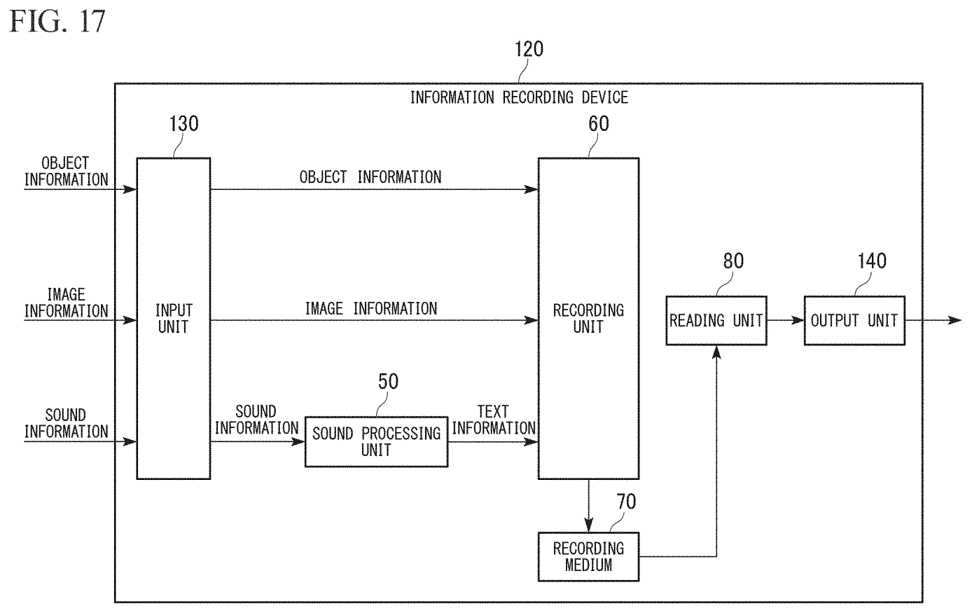

FIG. 17 shows a configuration of the information recording device 120. As shown in FIG. 17, the information recording device 120 includes a sound processing unit 50, a recording unit 60, a recording medium 70, a reading unit 80, an input unit 130, and an output unit 140.

The configurations of the sound processing unit 50, the recording unit 60, the recording medium 70, and the reading unit 80 are similar to those corresponding to the components shown in FIG. 1. Object information from the object information acquisition unit 20, image information from the image acquisition unit 30, and sound information from the sound acquisition unit 40 are input to the input unit 130. For example, at least one of the object information acquisition unit 20, the image acquisition unit 30, and the sound acquisition unit 40 is connected to the information recording device 120 through a cable. In this case, the input unit 130 is an input terminal to which the cable is connected. At least one of the object information acquisition unit 20, the image acquisition unit 30, and the sound acquisition unit 40 may be wirelessly connected to the information recording device 120. In this case, the input unit 130 is a wireless communication circuit that wirelessly communicates with at least one of the object information acquisition unit 20, the image acquisition unit 30, and the sound acquisition unit 40.

The output unit 140 outputs the object information, the image information, the sound information, and the text information read by the reading unit 80. That is, the output unit 140 outputs the object information, the image information, and the text information to the display unit 90 and outputs the sound information to the sound output unit 100. For example, at least one of the display unit 90 and the sound output unit 100 is connected to the information recording device 120 through a cable. In this case, the output unit 140 is an output terminal to which the cable is connected. At least one of the display unit 90 and the sound output unit 100 may be wirelessly connected to the information recording device 120. In this case, the output unit 140 is a wireless communication circuit that wirelessly communicates with at least one of the display unit 90 and the sound output unit 100.

The information recording device 120 may read a program and execute the read program. That is, the function of the information recording device 120 may be implemented by software. This program includes instructions for defining the operations of the sound processing unit 50, the recording unit 60, and the reading unit 80. For example, this program may be provided by a “computer-readable recording medium” such as a flash memory. Also, the above-described program may be transmitted from a computer having a storage device or the like in which the program is stored to the information recording device 120 via a transmission medium or transmission waves in the transmission medium. The “transmission medium” for transmitting the program refers to a medium having an information transmission function, for example, a network (a communication network) such as the Internet or a communication circuit (a communication line) such as a telephone circuit. Also, the above-described program may be a program for implementing some of the above-described functions. Further, the above-described program may be a program capable of implementing the above-described function in combination with a program already recorded on the computer, i.e., a so-called differential file (differential program).

Various modifications applied to the information recording system 10 shown in FIG. 1 may be similarly applied to the information recording system 10c shown in FIG. 16. For example, the information recording system 10c may not include the sound acquisition unit 40, the sound processing unit 50, and the sound output unit 100. In this case, object information and image information are input to the input unit 130. The recording unit 60 records the object information and the image information on the recording medium 70 such that the object information and the image information are associated with each other. The reading unit 80 reads the object information and the image information from the recording medium 70. The output unit 140 outputs the object information and the image information read by the reading unit 80. The display unit 90 displays the object information and the image information output by the output unit 140 such that the object information and the image information are associated with each other.

The information recording system 10c does not include the sound output unit 100 and the recording unit 60 may not record sound information. In this case, the object information, the image information, and the sound information are input to the input unit 130. The recording unit 60 records the object information, the image information, and the text information on the recording medium 70 such that the object information, the image information, and the text information are associated with each other. The reading unit 80 reads the object information, the image information, and the text information from the recording medium 70. The output unit 140 outputs the object information, the image information, and the text information read by the reading unit 80. The display unit 90 displays the object information, the image information, and the text information output by the output unit 140 such that the object information, the image information, and the text information are associated with each other.

The information recording system 10c may not include the sound processing unit 50. In this case, the object information, the image information, and the sound information are input to the input unit 130. The recording unit 60 records the object information, the image information, and the sound information on the recording medium 70 such that the object information, the image information, and the sound information are associated with each other. The reading unit 80 reads the object information, the image information, and the sound information from the recording medium 70. The output unit 140 outputs the object information, the image information, and the sound information read by the reading unit 80. The display unit 90 displays the object information and the image information output by the output unit 140 such that the object information and the image information are associated with each other. The sound output unit 100 outputs a sound based on the sound information output by the output unit 140.

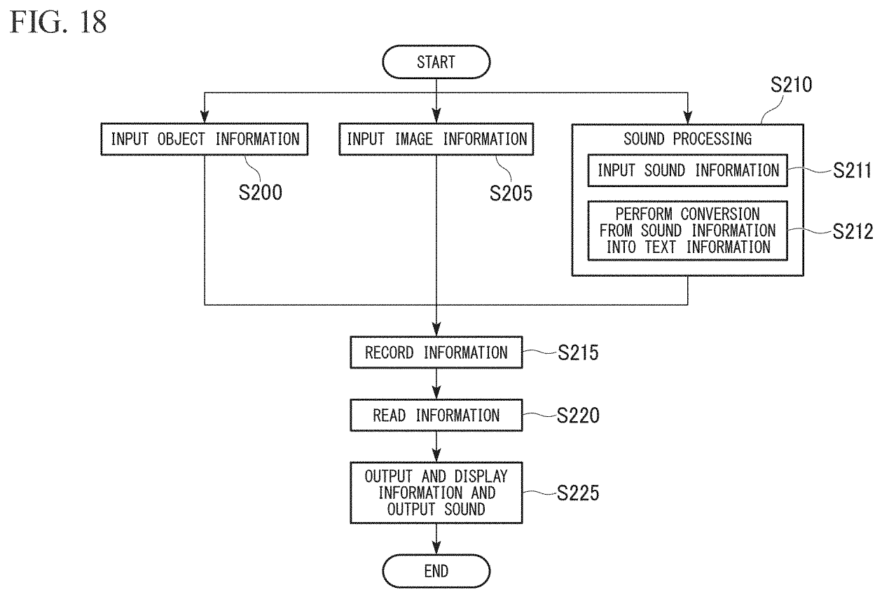

FIG. 18 shows a procedure of processing of the information recording device 120. The procedure of processing of the information recording device 120 will be described with reference to FIG. 18.

Object information about the object is input to the input unit 130 (step S200 (an input step)). The object information input in step S200 is stored in the buffer within the recording unit 60. In parallel with the input of the object information to the input unit 130, image information indicating a type of situation in which the object information was acquired is input to the input unit 130 (step S205 (an input step)). The image information input in step S205 is stored in the buffer within the recording unit 60. In parallel with the input of the object information to the input unit 130, the processing in step S210 is performed. Step S210 includes step S211 (a sound input step) and step S212 (a sound processing step). In step S211, sound information based on a sound uttered by an observer who observes the object is input to the input unit 130. In step S212, the sound processing unit 50 converts the sound information input to the input unit 130 into text information. In step S210, the processing in steps S211 and S212 is iterated. The sound information input in step S211 and the text information generated in step S212 are stored in the buffer within the recording unit 60.

Processing start timings of step S200, step S205, and step S210 may not be the same. Processing end timings of step S200, step S205, and step S210 may not be the same. At least some of periods during which the processing in step S200, step S205, and step S210 is performed overlap each other.

After the input of the object information, the image information, and the sound information is completed, the recording unit 60 records the object information, the image information, the sound information, and the text information stored in the buffer within the recording unit 60 on the recording medium 70 such that the object information, the image information, the sound information, and the text information are associated with each other (step S215 (a recording step)).

After step S215, the reading unit 80 reads the object information, the image information, the sound information, and the text information from the recording medium 70 (step S220 (a reading step)). The user may be able to specify a timing at which the information is read.

After step S220, the output unit 140 outputs the object information, the image information, the sound information, and the text information read by the reading unit 80. The display unit 90 displays the object information, the image information, and the text information output by the output unit 140 such that the object information, the image information, and the text information are associated with each other. Also, the sound output unit 100 outputs a sound based on the sound information output by the output unit 140 (step S225 (an output step, a display step, and a sound output step)).

When the information recording system 10c does not include the sound acquisition unit 40 and the sound processing unit 50, the processing in step S210 is not performed. Also, in step S215, the recording unit 60 records the object information and the image information on the recording medium 70 such that the object information and the image information are associated with each other. In step S220, the reading unit 80 reads the object information and the image information from the recording medium 70. In step S225, the output unit 140 outputs the object information and the image information read by the reading unit 80. Also, in step S225, the display unit 90 displays the object information and the image information output by the output unit 140 such that the object information and the image information are associated with each other.

When the information recording system 10c does not include the sound output unit 100 and the recording unit 60 does not record sound information, the recording unit 60 records the object information, the image information, and the text information on the recording medium 70 such that the object information, the image information, and the text information are associated with each other in step S215. In step S220, the reading unit 80 reads the object information, the image information, and the text information from the recording medium 70. In step S225, the output unit 140 outputs the object information, the image information, and the text information read by the reading unit 80 in step S220. Also, in step S225, the display unit 90 displays the object information, the image information, and the text information output by the output unit 140 such that the object information, the image information, and the text information are associated with each other.

When the information recording system 10c does not include the sound processing unit 50, the processing in step S212 is not performed. Also, in step S215, the recording unit 60 records the object information, the image information, and the sound information on the recording medium 70 such that the object information, the image information, and the sound information are associated with each other. In step S220, the reading unit 80 reads the object information, the image information, and the sound information from the recording medium 70. In step S225, the output unit 140 outputs the object information, the image information, and the sound information read by the reading unit 80 in step S220. Also, in step S225, the display unit 90 displays the object information and the image information output by the output unit 140 such that the object information and the image information are associated with each other. Also, in step S225, the sound output unit 100 outputs a sound based on the sound information output by the output unit 140.

At least one of the sound processing unit 50 and the recording medium 70 may be disposed outside the information recording device 120. When the sound processing unit 50 is disposed outside the information recording device 120, the text information from the sound processing unit 50 is input to the input unit 130. The recording medium 70 may be attachable to and detachable from the information recording device 120. The information recording device 120 may have a network interface and the information recording device 120 may be connected to the recording medium 70 via a network. The information recording device 120 may have a wireless communication interface and the information recording device 120 may be connected to the recording medium 70 through wireless communication.

The information recording device 120 may not include the reading unit 80 and the output unit 140. For example, the recording medium 70 is configured such that the recording medium 70 can be attached to or detached from the information recording device 120. When the recording medium 70 is detached from the information recording device 120 and is attached to a device outside the information recording device 120, the device can use the information recorded on the recording medium 70. When the information recording device 120 does not include the reading unit 80 and the output unit 140, the information recording device 120 does not perform the processing in steps S220 and S225.

As described above, object information is input to the input unit 130 and image information indicating a type of situation in which the object information was acquired is input to the input unit 130. The input object information and image information are recorded on the recording medium 70 by the recording unit 60. Thereby, the information recording device 120 can record visual information indicating a type of situation in which the object information was acquired. An effect obtained in the information recording system 10 of the first embodiment can be similarly obtained also in the information recording device 120 of the second embodiment.

In each of the systems shown in FIGS. 3 to 7, parts corresponding to the sound processing unit 50, the recording unit 60, the recording medium 70, and the reading unit 80 may be changed to a configuration corresponding to the information recording device 120. The matters disclosed in the first to third modified examples of the first embodiment may be similarly applied to the information recording device 120 of the second embodiment. Therefore, the information recording system 10c may include the situation information acquisition unit 110 and the situation information acquired by the situation information acquisition unit 110 may be input to the input unit 130.

While preferred embodiments of the invention have been described and shown above, it should be understood that these are exemplars of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information recording system comprising:
an object information acquisition unit configured to acquire object information about an object;
an image acquisition unit configured to acquire image information indicating a situation in which the object information was acquired by the object information acquisition unit;
a recording unit configured to record the object information and the image information on a recording medium such that the object information and the image information are associated with each other;
a reading unit configured to read the object information and the image information from the recording medium; and
a display unit configured to display the object information and the image information read by the reading unit such that the object information and the image information are associated with each other.

2. The information recording system according to claim 1, wherein the image acquisition unit acquires the image information including an image of surroundings of the object.

3. The information recording system according to claim 2, wherein the surroundings of the object include a device equipped with the object information acquisition unit.

4. The information recording system according to claim 2, wherein the surroundings of the object include an observer who observes the object.

5. The information recording system according to claim 1, wherein the image acquisition unit is disposed at a position of a viewpoint of an observer who observes the object or a position near the viewpoint.

6. The information recording system according to claim 1, further comprising a situation information acquisition unit configured to acquire situation information that indicates a type of situation in which the object information was acquired and is information other than the image information of the object.

7. The information recording system according to claim 6, wherein the situation information is information about at least one of a time point, a place, and a surrounding environment of the object.

8. The information recording system according to claim 6, wherein the situation information is device information about a device including the object information acquisition unit.

9. The information recording system according to claim 8, wherein the device information is a setting value of the device.

10. The information recording system according to claim 1,
wherein the recording unit records the object information, the image information, and time point information on the recording medium such that the object information, the image information, and the time point information are associated with each other, and
the reading unit reads the object information and the image information associated with each other from the recording medium on the basis of the time point information.

11. The information recording system according to claim 1, further comprising:
a sound acquisition unit configured to acquire sound information based on a sound uttered by an observer who observes the object; and
a sound processing unit configured to convert the sound information acquired by the sound acquisition unit into text information,
wherein the recording unit records the object information, the image information, and the text information on the recording medium such that the object information, the image information, and the text information are associated with each other,
the reading unit reads the object information, the image information, and the text information from the recording medium, and
the display unit displays the object information, the image information, and the text information read by the reading unit such that the object information, the image information, and the text information are associated with each other.

12. The information recording system according to claim 1, further comprising:
a sound acquisition unit configured to acquire sound information based on a sound uttered by an observer who observes the object; and
a sound output unit,
wherein the recording unit records the object information, the image information, and the sound information on the recording medium such that the object information, the image information, and the sound information are associated with each other,
the reading unit reads the object information, the image information, and the sound information from the recording medium,
the display unit displays the object information and the image information read by the reading unit such that the object information and the image information are associated with each other, and
the sound output unit outputs a sound based on the sound information read by the reading unit.

13. The information recording system according to claim 1, further comprising:
a sound acquisition unit configured to acquire sound information based on a sound uttered by an observer who observes the object; and
a sound processing unit,
wherein the recording unit records the object information, the image information, and the sound information on the recording medium such that the object information, the image information, and the sound information are associated with each other,
the reading unit reads the sound information from the recording medium,
the sound processing unit converts the sound information read by the reading unit into text information,
the recording unit associates the text information with the object information and the image information recorded on the recording medium and records the text information on the recording medium,
the reading unit reads the object information, the image information, and the text information from the recording medium, and
the display unit displays the object information, the image information, and the text information read by the reading unit such that the object information, the image information, and the text information are associated with each other.

14. The information recording system according to claim 1,
wherein the object information acquisition unit acquires the object information by imaging the object, and
the image acquisition unit acquires the image information by imaging the surroundings of the object with a visual field wider than that of the object information acquisition unit.

15. An information recording device comprising:
an input unit to which object information acquired by an object information acquisition unit and image information indicating a situation in which the object information was acquired by the object information acquisition unit are input, the object information being information about an object; and
a recording unit configured to record the object information and the image information on a recording medium such that the object information and the image information are associated with each other.

16. An information recording method comprising:
an object information acquisition step in which an object information acquisition unit acquires object information about an object;
an image acquisition step in which an image acquisition unit acquires image information indicating a situation in which the object information was acquired by the object information acquisition unit;
a recording step in which a recording unit records the object information and the image information on a recording medium such that the object information and the image information are associated with each other;
a reading step in which a reading unit reads the object information and the image information from the recording medium; and
a display step in which a display unit displays the object information and the image information read by the reading unit such that the object information and the image information are associated with each other.
